(19) United States
(12) Patent Application Publication
(10) Pub. No.: US 2006/0151247 A1
(43) Pub. Date: Jul. 13, 2006

(54) Electromagnetic release

(75) Inventors: Wolfgang Raffler, Headland, AL (US); Wolfgang Stiegeler, Ozark, AL (US)

Correspondence Address: LEVENFELD PEARLSTEIN;Intellectual Property Department, 2 North LaSalle, Suite 1300, CHICAGO, IL, 60602, US

(73) Assignee: MAHA USA, LLC

(21) Appl. No.: 11/007,006

(22) Filed: Dec. 8, 2004

(51) Int. Cl. B66F 7/10

(52) U.S. Cl. 187/208

(57) ABSTRACT

A vehicle lift with an electric power drive unit with control and switching means is disclosed having at least one lift carriage with a support column with at least one support arm with at least one support surface for a vehicle, said lift carriage with outrigger for vehicle support arm vertically movable and capable of being locked in place and released from being locked by operation of an electric solenoid and operation of the electric power drive unit with means for positive operator activation and positive operator control for safety operation of the vehicle lift. The disengaging of the spring activated latching mechanism coincides with the upward movement of the lift carriage to disengage the lift carriage from the spring activated latching mechanism.

This invention concerns conventional lifting platforms for motor vehicles with at least one column and with at least one support arm that can be moved in vertical guides of the column to lift support surfaces for a motor vehicle, the vertical movement of the support arm obtained by means of an electric power drive unit, with control and switching means for normal and non-normal operating modes.

This invention accordingly relates to safety devices for use with elevator devices, automobile lifts and the like and more particularly to a mechanism for preventing possible dangerous lowering of the lift in the event of failure of the elevating means. This invention has as its principal object the provision of improved and simplified safety locking means for vehicle lifts and elevator devices of one to four column supports.

This invention has as its principal object the provision of a safety latch release process mechanism for operation of a vehicle lift wherein the safety latch release mechanism comprises a process mechanism in that two safety release movements of the safety latch locking means provide an improved safety latch release process mechanism.

In the operation of lifts of the above-indicated type and of other varieties, the load is sustained by wire rope or cables, hydraulic cylinder pressure maintained by water or other liquids, pneumatic cylinder pressure maintained by pressurized air, chain lifts in conjunction with ratchet wheels, and other means of obtaining and maintaining lift conjointly with control of the lift process. All of the methods of lifting and sustaining the load utilize safety means characterized as positive engagement mechanical locking safety devices capable of maintaining the load in any number of raised positions should a failure occur. Safety apparatus can be provided to prevent excessive tilt or cant of a load in the event a force equalizing apparatus fails that might cause the object being lifted to spill over and be damaged. Safety devices can be provided to prevent possible dangerous lowering of the lift in the event of failure of the elevating means.

While commercially available lift equipment is of such reliable and uniform character that the danger of lift failure is extremely remote, even in the event of long-continued neglect or abuse, it is highly desirable to guard against even such a remote contingency, since men must usually work directly beneath the lift and a failure might cause damage to valuable property even if it did not result in serious injury to the workman. The present invention accordingly has as its principal object to provide an improved safety latch release mechanism for operation of a vehicle lift wherein the safety latch for the lift is released to permit downward movement of the lift by simultaneous rotation of the safety latch from a locking position which engages the vehicle lift carriage and an upward movement of the vehicle lift carriage which supports the vehicle to permit rotation of the safety latch from its engagement with the vehicle lift carriage.

In the prior art, the safety apparatus, if used at all, is frequently manually activated or an automatic lock mechanism is provided which prevents the accidental downward displacement of the vehicle supporting lift platform, U.S. Pat. No. 5,018,925 to Ganser teaches a lifting device driven by a drive motor wherein the lift platforms are held at all four corners on a chain hoist with the chain hoists engaging the four corners being wound up and down synchronously by means of gear teeth meshing with the chain hoists. The position of the gear teeth relative to the chain hoist determines the height of the lift. When four separate chain hoists are used, such arrangement involves the difficulty to insure synchronous lifting motion of the four chain hoists and thus prevent unwanted tilting of the lifting platform. A separate gear and chain arrangement avoids unintentional pivoting.

U.S. Pat. No. 4,763,761 to McKinsey teaches a safety structure to prevent excessive tilt or sudden drop of a hydraulic lift structure for automobiles which consists of a base with two hydraulic vertical lifting columns, a vertically moving carriage for lifting an object and a weight and lift equalizing apparatus. A safety apparatus comprising positive engagement mechanical devices of springs and catches engages slots in the support columns as the lifting columns are raised. In normal use, when the lifting carriage is lowered, the safety structure must be disabled. This is done by manually rotating the catches to pull back the lower portion of the catches from the slots in the support columns by the use of cables which must be pulled and held when the lifting apparatus is lowered. Such disabling must be done by an external operator or by manual means through a release lanyard at the time of lowering. U.S. Pat. No. 4,457,401 to Taylor teaches a vehicular hydraulic lift comprising a releasable automatic locking means comprising a pawl mechanism and including a cable for releasing the locking means. A manually operated release mechanism controls the lowering of the lift subject to the hydraulic system and a sensing mechanism can override the manual operation and control in the event of any malfunction by returning the automatic locking pawl to an engaged position. U.S. Pat. No. 3,789,958 to Masaitis teaches a vehicle support hoist utilizing hydraulic or pneumatic cylinders which provides a locking means to lock the supporting posts for the vehicle comprising a latching means of pins inserted through holes in the supporting posts. In operation, the vehicle is raised on the hoist, the pins are inserted in the post holes to secure the vehicle in position and to allow work to be performed on the suspended vehicle. After the work is done, the pins are removed and the hoist is lowered. Removal and insertion of the locking pins are selectively operable and positioned wherein the latching means comprises aligned pin receiving holes. U.S. Pat. No. 2,750,004 to Harrison teaches a combined load-equalizing and safety device for hydraulic-operated automotive lifts and elevators with means for preventing dangerous lowering of the lift in the event of failure of the elevating means. The safety device utilizes a manually operable pawl engageable with a ratchet wheel so that when the pawl is engaged with the ratchet wheel teeth, the ratchet wheel prevents downward movement of the lift, the ratchet wheel being secured to two sprocket wheels. The sprocket wheels mesh with the lift mechanism when the lift is raised or lowered. A tension spring causes positive engagement of the pawl with the ratchet wheel teeth so that the lift cannot be lowered unless the pawl is disengaged. A separate handle is provided to manually disengage the pawl from the ratchet wheel teeth against the pressure exerted by the tension spring. U.S. Pat. No. 2,564,267 teaches a safety mechanism for vehicle hoists powered by an electric motor which utilizes a mechanical screw device operable by a rotatable means such as a crank or wrench to turn the screw device. A winch driven by an electric motor raises and lowers the hoist by means of a cable. A friction brake acting on the shaft of the electric motor acts on the raising and lowering of the hoist by means of the cable. The mechanical screw device manually controls the friction brake by controlling release of the friction brake and movement of the cable. An automatic safety device is provided for cable breaks by a lever-type locking dog wherein the release is manually operated and requires mechanical engagement. U.S. Pat. No. 2,517,318 to Jeffers teaches a vehicle hoist with an electric motor power unit which uses latch bars which ratchet in and out of holes to prevent falling of the support frame as the latch means. The latch means are spring activated to engage. Manually operated means disengage the latch means by the turning of a crank to allow the hoist frame to be lowered.

Although elements of problems addressed by the instant invention have been taught in the prior art, i.e., safety latches and the release of safety latches by activation of cable mechanisms by manual means or by manual release of safety latches, the use of linear activators such as hydraulic pumps or cylinders operated by a prime mover such as an electric motor, automatic locking mechanisms such as pawls held in position by springs and released by manual activation, the use of manual insertion and removal of pins from pin receiving sockets in support elements such as hoist lift posts to provide a safety means, the problem of positive operational control of the safety elements adherent in the operation of an automotive lift is believed by the inventors to remain.

It is therefore an object of the instant invention to provide a means of positive activation of the safety elements of an automotive lift.

It is a further object of the instant invention to provide a means of positive control of the safety elements of an automotive lift.

It is a further object of the instant invention to provide an alternative means of positive activation and control of the safety elements of an automotive lift wherein use of manually operated wire cables and ropes to activate and release safety devices is eliminated, the use of hydraulic systems as operational devices to operate safety devices, and the use of pressured air pneumatic cylinders and the related provision for sources of hydraulic pressure and pressurized air to operate safety devices are rendered unnecessary.

It a further object of this invention to provide a means of positive control and activation of the safety elements of an automotive lift wherein the system of control and activation is by an easily installed electrical connection between the point of control and activation and the safety elements of the automotive lift.

It is a further object of this invention to provide an electrical means of control and activation of the safety elements of the automotive lift wherein the electrical means of control and activation can be integrated with a warning light system and computer programs with added safety features.

### SUMMARY OF THE INVENTION

A safety latch release process mechanism for a vehicle lift with at least one lift column is disclosed, with at least one support arm that can be moved in vertical guides of the column and that features support surfaces for the motor vehicle, with an electric motor drive unit, which is connected to the support arm via a connection means, which has control and switching means for normal and non-normal operating modes, and an automatic safety mechanism comprising an automatic locking spring mechanism with a means for positive activation and positive operator release of the locking mechanism and optional provision for auxiliary positive indication of release of the locking mechanism by auxiliary warning indicators. A solenoid is activated to disengage the automatic locking mechanism by a positive operator activation signal. The automatic locking mechanism and solenoid disengaging latch release on the lift carriage mechanism operate as safety means concurrently in conjunction with upward movement of the lift carriage of the vehicle lift wherein upward movement of the lift carriage acts to disengage the hole cutouts of the lift carriage from the lift latch coinciding with operation of the solenoid disengaging mechanism to provide an improved safety latch release mechanism.

### BRIEF DESCRIPTION OF THE DRAWINGS

FIG. 1 is a front view of the lifting device for motor vehicles with vehicle support arms, two support columns and automatic spring activated latching mechanisms operational within each column wherein release of the latching mechanism is activated by operator control of a solenoid latching release mechanism.

FIG. 2 is a perspective view of the operational elements of the spring activated latching mechanism mounted on the support column and the lift carriage of the lifting platform for motor vehicles wherein the lift carriage fits inside the support column and the automatic mechanical latching mechanisms operational thereon each support column, wherein the automatic mechanical latching mechanism on each support column engages a series of hole cutouts on the lift carriage and vertical movement of the lift carriage disengages the hole cutouts of the lift carriage from the spring activated latch catches of the spring activated latching mechanism mounted on the support column. Vertical guides (in dotted lines) on the support column maintain the lift carriage in vertical position within the enclosure of the lift column.

FIG. 3 is a side view of the automatic spring activated latching mechanism and the solenoid means for disengaging the automatic spring activated latching mechanism mounted upon the support column by rotating the latch catches against the spring capacity from engaged position as a safety latch to a disengaged position.

FIG. 4 is a top view of the automatic spring activated latching mechanism and the solenoid means for disengaging the automatic spring activated latching mechanism of FIG. 3.

FIG. 5 is a perspective view of the lift with outriggers and the series of hole cutouts which are engaged by the spring activated mechanical latching mechanism, and the anchor support lift cable of the lift carriage.

FIG. 6 is a perspective view of the lift carriage with outriggers and the anchor support lift cable of the lift carriage.

### DETAILED DESCRIPTION OF ILLUSTRATIVE EMBODIMENT

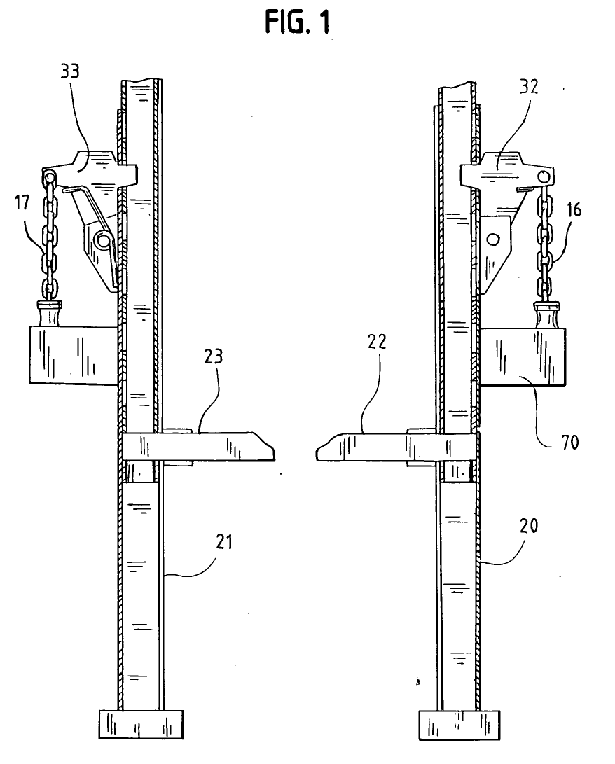

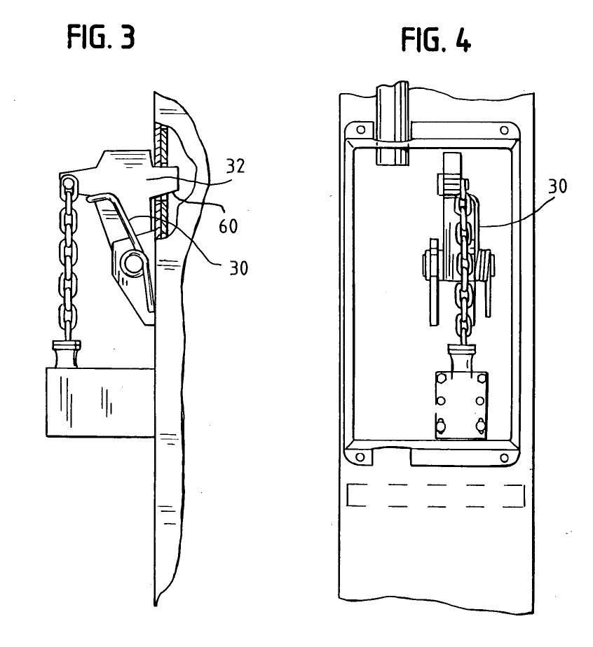

Reference is now made to FIGS. 1-6 wherein is shown the safety latch release mechanism comprising an automatic locking mechanism with means for positive activation and positive operator control of the safety elements of an automotive lift.

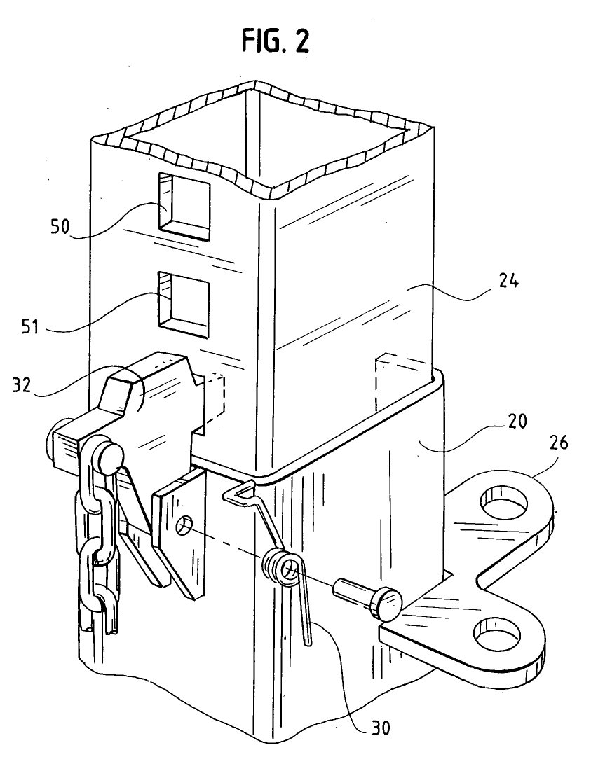

The lift device includes a pair of vertical support columns 20 and 21 having support base structures at the foot of the support columns (not shown) for interfacing with the underlying support medium, such as a concrete floor (also not shown). The vertical support columns have vertical guides, shown in dotted lines in FIG. 2, which maintain the lift carriages 24 and 25 in vertical position within the enclosure of support columns 20 and 21.

The lifting device includes a pair of vehicle support arms 22 and 23 that engage the vehicle to be lifted. Support arms 22 and 23 are engaged by lift carriages 24 and 25 (lift carriage 25 not shown) by outriggers 26 and 27 which lift by overhead lifting cables 130 and 131 (outrigger 27 and lifting cable 131 not shown) wherein the vertical lift motion is provided by suitable means such as hydraulic means and a power unit, conventionally an electric motor as a prime mover.

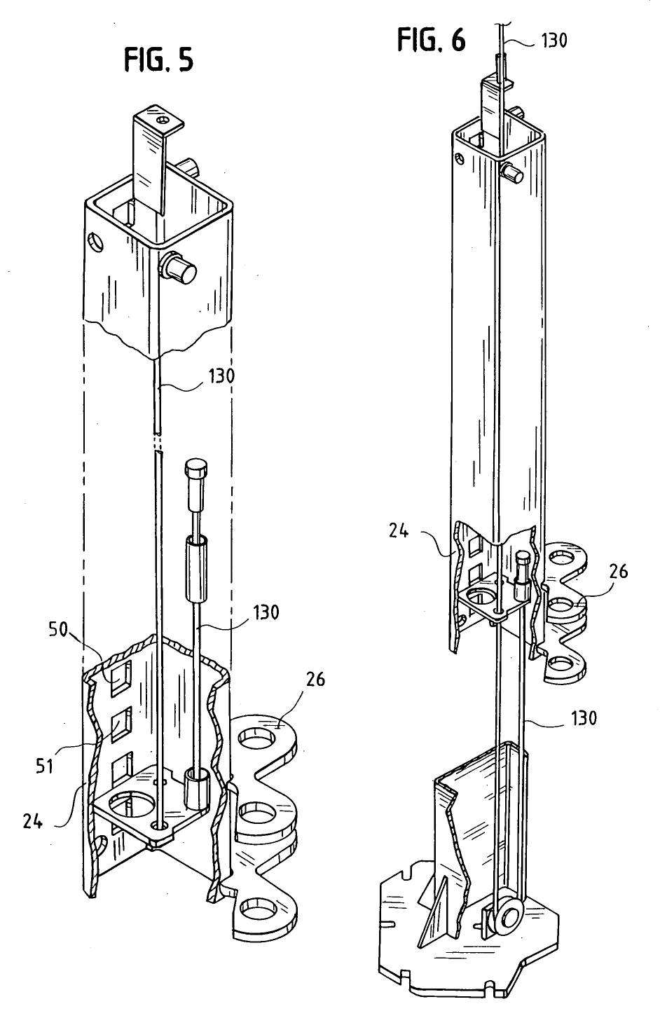

The pair of lift carriages 24 and 25 have multiple vertically spaced hole cutouts (50 and 51 in FIGS. 2 and 5) running the length of the vertical lift carriages, each hole cutout positioned in each lift carriage 24 and 25 to be in alignment in vertical travel with the spring activated latching mechanism supported on support column 20 and with an equivalent positioned spring activated latching mechanism on support column 21. The support arms 22 and 23 are positioned and engaged by outriggers 26 and 27 on the lift carriages 24 and 25 in vertical travel along the path provided by the vertical support columns 20 and 21.

Positive engagement latch mechanisms spring actuated and disengaged by action of a linear motion solenoid engage the vertically spaced hole cutouts (50 and 51 of lift carriage 24) of lift carriages 24 and 25, running the height of vertical support columns 20 and 21. Coil springs 30 and 31 maintain positive engagement action of the latch catches 32 and 33 by forcing the latch catches 32 and 33 into position to engage hole cutouts (exemplified 50 and 51 of lift carriage 24) of the vertical lift carriages 24 and 25 in a fail safe condition to thus prevent downward movement of the support arms 22 and 23. Latch catches 32 and 33 have tapered surfaces 60 and 61 to ease the contact of the latches 32 and 33 with the bottom surface of hole cutouts (50 and 51 of lift carriage 24) when the lift carriages 24 and 25 are being raised.

In FIG. 1 chain links 16 and 17 as operational linkage between the latch catches and the solenoid are attached to latch catches 32 and 33 to rotate the latch catches 32 and 33 from the engaged hole cutouts 50 and 51 by activation of solenoid 70 caused by the operator's activation of an electrical contact. An alternative operational linkage comprises a suitable cable linkage. Because the latch catches 32 and 33 are in a locked position due to the downward weight of the lift vehicle upon the surfaces of the latch catches, the latch catches must be rotated by pulling the latch catches from position within the vertically spaced hole cutouts wherein the lift carriage is raised slightly from the locked position to allow latch catches 32 and 33 to rotate from locked position and thus free the rotatable latch members from locked position. The upward movement of the lift carriage coincides with activation of solenoid 70 with control and switching means of the electric power drive unit for indication of the safety latch release mechanism condition. If the lift carriage fails to move upward to release the safety latch catch from engaged position, a related warning indicator as to the position of the safety latches can inform the lift operator as to condition of the lift.

Solenoid 70 is preferably an iron core plunger solenoid wherein an iron core surrounds the coil winding to increase the magnetic pull on the plunger. An ac or a dc solenoid can be used depending upon the operating voltage, speed of operation required and electrical connection available. As is well-known, a dc solenoid can provide a more consistent speed of operation, a dc solenoid being driven from an ac source by including a rectifier and capacitive filtering. In operation, the speed of operation can be increased by preferably lubricating the plunger with a dry lubricant.

An electric power drive unit and motor assembly of conventional construction (not shown) is supported on each support column and is controlled by conventional electrical control means or switches by which the operator activates the solenoid and the upward displacement of the lift carriages to allow the latch catches to rotate from locked position in the hole cutouts of the lift carriages.

The instant invention accordingly also can provide a positive operational indication and control of the safety elements adherent in the operation of an automotive lift by providing for a separate auxiliary electrical system notifying the lift operator of safe operation. The electrical operation of the solenoid device can implement the activation of warning indicators as to the position of the safety latches and the vertically spaced slots in the lift carriages. The operator accordingly can be currently informed as to the safe condition of the vehicle lift. The warning indicators will provide positive indications as to the positions of the safety latch catches and the slots in the lift carriages and whether the latches and slots are activated into “release” positions and whether the latches and slots remain engaged in safe positions to enhance the safe operation of a vehicle lift.

While the described embodiment has been of a double column vehicle lift, the instant invention is applicable on any lift which has safety aspects and utilizes a safety latch. Operational difficulties occasioned by manual operation of safety latches due to inoperative cables, lack or failure of hydraulic systems, and similar operational difficulties are avoided. The instant invention can be applied to a single column lift for vehicles as well as to any lift using hydraulic, or any source of lift power.

What is claimed is:

1. A lifting platform for raising and lowering an automotive vehicle comprising at least one support column and a lift carriage with at least one vehicle support arm with at least one support surface for a vehicle, said lift carriage vertically movable in vertical guides of said support column, with an electric power drive unit and motor assembly connected to said lift carriage, which electric power drive unit and motor assembly has control and switching means for normal and non-normal operating modes, a spring activated latch engagement mechanism for locking said lift carriage in position and solenoid activated latch release mechanism in said support column with positive safety latching activation and means for operator positive disengagement of said spring activated latch mechanism wherein said spring activated latch engagement mechanism comprises:
a rotatable latch member on a pivot axis mounted upon said support column, said latch member positioned to engage hole cutouts of said lift carriage in locking position to lock said lift carriage against downward movement
a coil spring mounted on said pivot axis positioned to force said latch member to engage hole cutouts of said lift carriage
an electric solenoid connected by suitable means to said rotatable latch member, said solenoid positioned below said latch member to cause said latch member, upon solenoid activation, to rotate out of locking position to disengage hole cutouts of said lift carriage, said solenoid acting against the positive engagement action of said coil spring forcing said latch member to engage hole cutouts of said lift carriage
means for said operator positive disengagement of said spring activated latch engagement mechanism which comprises:
said electrical control and switching means of said electric solenoid and said electric power drive unit whereby said electric solenoid is activated by operator electrical control and said electric power drive unit is activated to raise the lift carriage to free said rotatable latch members from locked position in engaged hole cutouts of said lift carriage.

2. A lifting platform according to claim 1 wherein said electric solenoid latch release mechanism consists of an electric solenoid, a spring activated latching mechanism disengaged by said electric solenoid mechanism, a connecting means between said electric solenoid and said spring activated latching mechanism, and an electric power cable to said electric solenoid with associated control means.

3. A lifting platform according to claim 1 wherein said spring activated latching mechanism and disengaging solenoid mechanism of said spring activated latching mechanism consists of a solenoid affixed to said support arm and operational linkage to said spring activated latching mechanism wherein said solenoid, upon electrical activation, acts to disengage said spring activated latching mechanism from said hole cutouts in said lift carriage by rotating latch catches of said spring activated latching mechanism from said hole cutouts and said hole cutouts in said lift carriage are disengaged from said latch catches of said spring activated latching mechanism by coinciding upward movement of said lift carriage.

4. A lifting platform according to claim 1 wherein said means for positive operator activation and positive operator control of said safety locking mechanism consists of an electric solenoid mechanism and indication means of locking status of said safety locking mechanism and said locked status of said hole cutouts in said lift carriage.

5. The operational linkage of claim 3 between said spring activated latching mechanism and said electric solenoid mechanism which comprises a connecting cable or connecting chain links.

6. The lifting platform of claim 1 wherein indication of the safety latch release mechanism condition is provided by warning indicators.
